(19) United States
(12) Patent Application Publication
(10) Pub. No.: US 2014/0068354 A1
(43) Pub. Date: Mar. 6, 2014

(54) APPARATUS AND METHOD FOR DETERMINING A STATE OF A MOBILE TERMINAL

(71) Applicant: PANTECH CO., LTD., Seoul (KR)

(72) Inventors: Jin-Ho PARK, Gwangmyeong-si (KR); Tae-Kyu KIM, Incheon-si (KR); Hyun-Sung KIM, Seoul (KR)

(73) Assignee: Pantech Co., Ltd., Seoul (KR)

(21) Appl. No.: 13/773,009

(22) Filed: Feb. 21, 2013

(30) Foreign Application Priority Data
Sep. 6, 2012 (KR) 10-2012-0098905

(51) Int. Cl. G06F 11/07

(52) U.S. Cl. CPC G06F 11/0757
USPC 714/55

(57) ABSTRACT

A method for determining an operational status of a terminal includes transmitting, from a first processor to a second processor, a request for determining a status of the second processor; executing a timer operation for a time period; determining that the second processor is in a hang state if a response message is not received from the second processor within the time period; and transmitting a reboot command for rebooting the second processor. A terminal includes a first processor to transmit a status request message to a second processor, to initialize a timer to run until expiration of a time period, and to transmit a reboot command to a power management unit if the response message is not received within the time period; and the second processor to transmit a response message prior to expiration of the time period if the second processor is operating normally.

### CROSS-REFERENCE TO RELATED APPLICATION

This application claims priority to and the benefit under 35 U.S.C. §119(a) of Korean Patent Application No. 10-2012-0098905, filed on Sep. 6, 2012, the entire disclosure of which is incorporated herein by reference for all purposes.

### BACKGROUND

1. Field

The following description relates to an apparatus and a method for detecting and resolving a hang state in a terminal.

2. Discussion of the Background

Often, an application of a mobile terminal suddenly freezes and does not respond to inputs. This kind of malfunction is referred to as a hang state. A system hang state indicates a situation where inputting and outputting processes of a mobile device stop performing due to software or hardware problems in the mobile device.

The hang state can be triggered largely for two reasons, (1) a malfunction of a major component (e.g., a Central Processing Unit (CPU), a kernel, and the like) of a system, or (2) a malfunction of a component responsible for inputting and outputting processes.

As mobile terminals are required to provide improved performance and perform more operations than ever before, their software and hardware have become more complicated. This trend has led to an unstable system of the mobile terminals, such that a hang state often occurs in a CPU or an Application Processor (AP) of the mobile terminals.

FIG. 1 is a flow chart illustrating the operation of a general watchdog program for detecting and resolving a hang state occurring in an AP.

Referring to FIG. 1, the general watchdog program for detecting and resolving a hang state uses a hardware timer. The watchdog program sets a target object and then initializes the hardware timer for a predetermined time period in operation 11. The watchdog program waits for the target object to transmit a report signal as the timer set by the watchdog program runs against the predetermined time period. In operation 15 and operation 16, the watchdog program checks the target object to determine whether the target object responded with the report signal. If the report signal is received from the target object before the predetermined time period set by the watchdog program has elapsed or expired, the watchdog program reinitializes the timer. If the report signal is not received from the target object before the predetermined time period has elapsed and the timer has expired in operation 12, the watchdog program, in operation 13, determines that a hang state has occurred in the target object. In operation 14, the watchdog program performs a predetermined operation in response to the occurrence of the hang state. Usually, a system is reset or rebooted in order to resolve the hang state.

However, in some cases, the watchdog program fails to detect a malfunction of the target object. The watchdog program usually detects a hang state when the target object fails to occupy a CPU and thus freezes. However, since the target object has not occupied the CPU, the target object cannot transmit a signal to initialize the watchdog program. Further, even if the target object has occupied the CPU and is capable of sending a report signal in spite of the malfunction, the watchdog program may be unable to generate an interrupt signal.

For example, although an operating system (OS) kernel module or a task to process a user interface has malfunctioned, a target object may be able to keep occupying the CPU and be executed. More specifically, if the target object transmits the report signal to the watchdog program despite the malfunction, the watchdog program cannot detect a hang state. However, a user of the mobile terminal may consider that a system hang state has occurred since the user interface does not work.

In addition, if there is a problem in the watchdog program itself, it may be difficult to detect or resolve a hang state of the watchdog program since the watchdog program is a software that is executed in an AP. For example, when the AP enters a sleep mode, the watchdog program is in a disabled state and a hang state cannot be detected or resolved.

### SUMMARY

Exemplary embodiments of the present invention provide an apparatus and a method for detecting and resolving a hang state in a terminal.

Additional features of the invention will be set forth in the description which follows, and in part will be apparent from the description, or may be learned by practice of the invention.

Exemplary embodiments of the present invention provide a method for determining an operational status of a terminal including transmitting, from a first processor to a second processor, a request message for determining a status of the second processor; executing a timer operation for a time period; determining that the second processor is in a hang state if a response message is not received from the second processor within the time period; and transmitting, to a power management unit, a reboot command for rebooting the second processor if the second processor is determined to be in the hang state.

Exemplary embodiments of the present invention provide a terminal including a first processor to transmit a status request message to a second processor, to initialize a timer to run until expiration of a time period, and to transmit a reboot command to a power management unit if the response message is not received within the time period; and the second processor to determine its status and to transmit a response message prior to expiration of the time period if the second processor is operating normally.

Exemplary embodiments of the present invention provide a method for determining an operational status of a terminal including transmitting, from a first processor to a second processor, a first request message for determining a status of the second processor; executing a timer operation for a time period; and determining that the second processor is in a hang state if a response message is not received from the second processor within the time period.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a flow chart illustrating a method for detecting and resolving a hang state according to a related art.

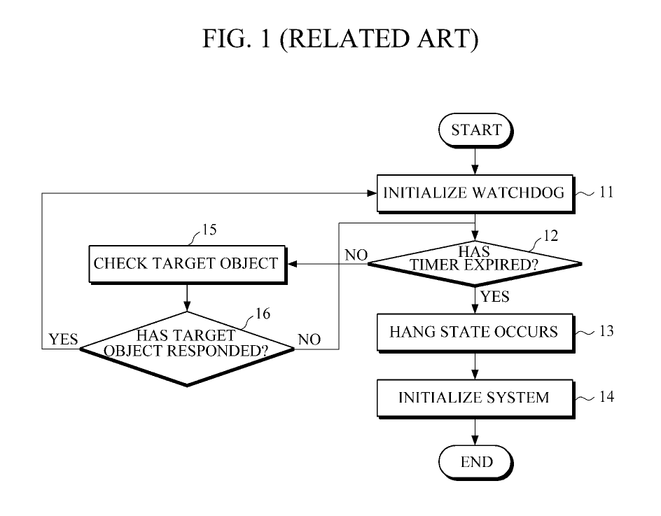

FIG. 2 is a diagram illustrating a configuration of an apparatus to manage a hang state according to an exemplary embodiment of the present invention.

FIG. 3 is a diagram illustrating a configuration of a hang state processing unit according to an exemplary embodiment of the present invention.

FIG. 4 is a diagram illustrating a configuration of a response processing unit according to an exemplary embodiment of the present invention.

FIG. 5 is a flow chart illustrating a normal operation for managing a hang state according to an exemplary embodiment of the present invention.

FIG. 6 is a flow chart illustrating a method for managing a hang state according to an exemplary embodiment of the present invention.

FIG. 7 is a flow chart illustrating a method for managing a hang state according to an exemplary embodiment of the present invention.

FIG. 8 is a flow chart illustrating a method for generating a response message according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify he presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

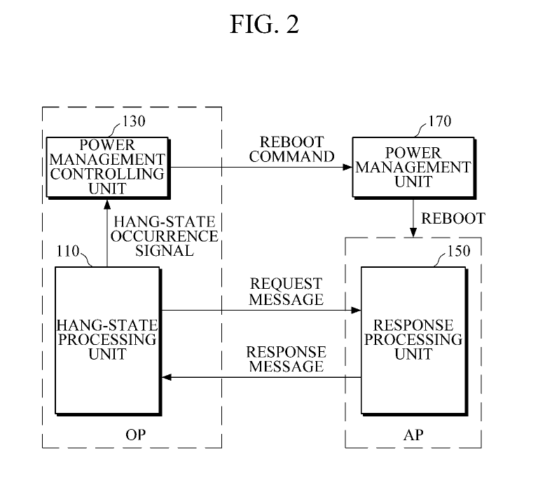

FIG. 2 is a diagram illustrating a configuration of an apparatus to manage a hang state according to an exemplary embodiment of the present invention.

Referring to FIG. 2, the apparatus to manage a hang state includes a hang-state processing unit 110, a power management controlling unit 130 and a response processing unit 150.

The hang-state processing unit 110 and the power management controlling unit 130 may be disposed in an operating processor (OP). The OP may be located in an Application Processor (AP) but operate independent of the AP. The response processing unit 150 may be disposed in the AP. The OP may be a processor that operates independently without being controlled by the AP. More specifically, the OP may operate for purposes different from that of the AP, inside of a mobile terminal or other terminals. This kind of processor may operate independent of the AP in terms of operation and control, but may be physically connected to the AP. More specifically, the AP and the OP may be configured independently of each other or may be configured as one chip.

For example, the OP having other purposes that may be different from that of the AP may include at least one of a baseband modem processor (BP), a communication processor (CP), a digital signal processor (DSP), and the like. These processors may be embedded in a smart phone and other mobile terminals.

When an AP of a mobile terminal is in a hang state, not only the AP but also other chips or processors controlled by the AP may come to a stop or may malfunction. The OP, which may be located in the AP but operates independently from the AP, may be used, rather than the chips or processors that may be directly connected to or controlled by the AP, to detect and resolve the hang state.

The hang-state processing unit 110 may transmit, continuously or intermittently, a request message to the response processing unit 150 of the AP at predetermined or random time intervals. The request message may be a status request message to check whether the AP is operating properly. The hang-state processing unit 110 may transmit the request message to the response processing unit 150 included in the AP, and the response processing unit 150 may be requested to generates a response message, such as a status response message, in response to the request message.

In response to receiving the response message from the response processing unit 150, the hang-state processing unit 110 may determine that the AP may be operating properly.

In response to not receiving a response message from the response processing unit 150 within a predetermined time period, which may be set by a timer, the hang state processing unit 110 may determine that the AP may not be operating properly. If the AP is operating properly, the response processing unit 150 of the AP may transmit a response message in response to the request message. However, if the AP is in a hang state and unable to operate properly, the response processing unit 150 may be unable to generate and transmit the response message.

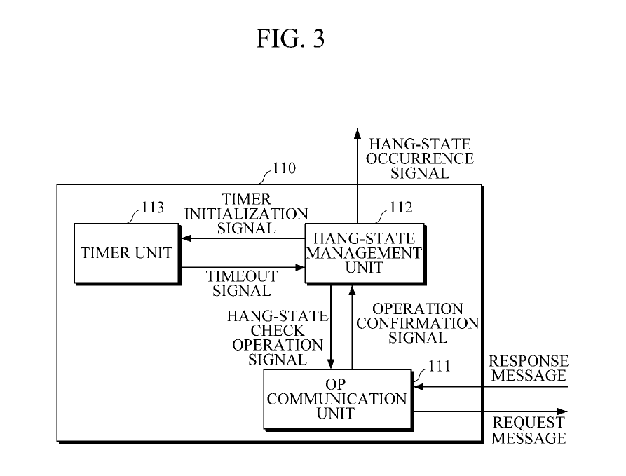

In response to not receiving a response message, the hang state processing unit 110 may determine that the AP is in a hang state, and may perform an operation to resolve the hang state. In order to resolve the hang state, the hang state processing unit 110 may notify the power management controlling unit 130 that the AP is in a hang state. A more detailed description about the configuration of the hang state processing unit 110 will be provided with reference to FIG. 3.

Upon being notified by the hang state processing unit 110 that the AP is in a hang state, the power management controlling unit 130 may transmit a reboot command to a power management unit 170 in an attempt to reboot the AP to resolve the hang state.

In response to the reboot command received from the power management controlling unit 130, the power management unit 170 may control power supply of the AP in an attempt to reboot the AP.

The power management unit 170 may be a device, which may control power supply of a mobile terminal. The power management unit 170 may include a Power Management Integrated Circuit (PMIC), which may be used to boost or extend battery life of a battery operated devices, such as a mobile terminal. However, aspects of the invention are not limited thereto, such that the power management unit 170 may include other power management components or integrated circuits. The power management unit 170 or PMIC may adjust core voltage to be suitable for a CPU (or an AP) in response to receiving an interface signal, which may correspond to a load to be processed by the CPU (or AP). Accordingly, the power management unit 170 may allow the CPU (or AP) to operate with reduced power consumption.

The response processing unit 150 may generate a response message in response to the request message received from the hang state processing unit 110. The response processing unit 150 may transmit the generated response message to the hang-state processing unit 110. More specifically, in response to receiving, from the hang-state processing unit 110, a request message for checking whether the AP is in a hang state, the response processing unit 150 may generate a response message and transmit the response message to the hang-state processing unit 110. Using the response message received from the response processing unit 150, the hang-state processing unit 110 may be able to determine whether the AP is in a hang state. If the AP is determined to be in a hang state and unable to operate properly, the response processing unit 150 included in the AP may be unable to generate and transmit a response message in response to the request message and the hang-state processing unit 110 may determine that the AP is in a hang state.

FIG. 3 is a diagram illustrating a configuration of a hang-state processing unit according to an exemplary embodiment of the present invention.

Referring to FIG. 3, a hang-state processing unit 110 may include an OP communication unit 111, a hang-state management unit 112 and a timer unit 113. The hang-state processing unit 110 may be arranged in the OP.

In response to receiving a hang-state check operation signal from the hang-state management unit 112, the OP communication unit 111 generates a request message, such as a status request message, to check whether an AP is in a hang state and transmits the request message to the response processing unit 150 of the AP.

If a response message is received from the response processing unit 150 in response to the request message, the OP communication unit 111 may generate an operation confirmation signal based on the received response message and transmits the operation confirmation signal to the hang-state management unit 112.

Generally, the OP communication unit 111 may be able to communicate with the AP using Inter-processor communication (IPC). The IPC may refer to a set of communication methods between processors. According to the IPC methods, communicable processors may share a predetermined variable and exchange data using (1) the predetermined variable, or (2) an operating system responsible for communication.

The timer unit 113 may execute a timing operation, which may be set having a predetermined time period. When the timing operation is executed, the predetermined time period runs until expiration or receives a signal to reinitialize the timing operation. More specifically, when the predetermined time has elapsed or expired, the timer unit 113 may transmit a timeout signal to the hang-state management unit 112. If the timer unit 113 receives a timer initialization signal from the hang-state management unit 112 before the predetermined time period has expired, the timer unit 113 may reinitialize the timing operation to be executed again from the beginning. The hang-state managing unit 112 may transmit the hang-state check operation signal and the timer initialization signal simultaneously or within a reference time period.

The hang-state management unit 112 may transmit the timer initialization signal to the timer unit 113. In addition, the hang-state management unit 112 may generate a hang-state check operation signal to check whether the AP is in a hang state, and transmit the generated hang-state check operation signal to the OP communication unit 111.

The hang-state management unit 112 may transmit the timer initialization signal to the timer unit 113 to initialize the timer unit 113. The hang-state management unit 112 may transmit the hang-state check operation signal to the OP communication unit 111 and may wait to receive an operation confirmation signal, which may help in confirming that the AP is in a hang state. In response to receiving the operation confirmation signal from the OP communication unit 111, the hang managing unit 112 may determine that the AP is operating properly (i.e., not in a hang state) and may transmit the timer initialization signal again to reinitialize the timer unit 113. The hang-state management unit 112 may perform the above-described process repeatedly to check whether the AP is in a hang state.

In response to receiving a timeout signal from the timer unit 113, the hang-state management unit 112 may determine that the AP is in a hang state and unable to operate properly. However, aspects of the invention are not limited thereto, such that the hang-state management unit 112 may determine that the AP is in a hang state in response to not receiving a signal from the timer unit 113 within a predetermined period of time. In response to the determination that the AP is in a hang state, the hang-state management unit 112 may transmit, to the power management controlling unit 130, a hang-state notification signal indicating that the AP is in a hang state to reboot the AP.

Although separate components are illustrated in FIG. 3, aspects of the invention are not limited thereto, such that two or more components may be integrated to operate as a single component.

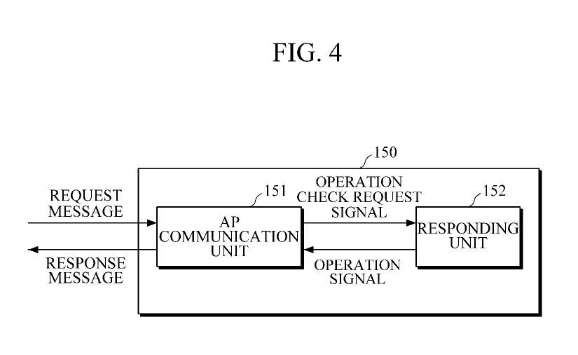

FIG. 4 is a diagram illustrating a configuration of a response processing unit according to an exemplary embodiment of the present invention.

Referring to FIG. 4, a response processing unit 150 includes an AP communication unit 151 and a responding unit 152. The response processing unit 150 may be arranged in an AP of a mobile terminal.

In response to receiving a request message from a hang-state processing unit 110, the AP communication unit 151, which may be disposed in a kernel layer, generates an operation check request signal and transmits the operation check request signal to the responding unit 152. The responding unit 152 transmits an operation signal to the AP communication unit 151 in response to receiving the operation check request signal, and the AP communication unit 151 transmits a response message based on the operation signal to the hang-state processing unit 110.

In response to receiving the operation check request signal from the AP communication unit 151, the responding unit 152 disposed in a framework layer transmits the operation signal to the AP communication unit 151.

If the AP is determined to be in a hang state and unable to operate properly, the responding unit 152 may be unable to transmit the operation signal since the responding unit 152 is included in the AP. Therefore, the AP communication 151 may be unable to transmit a response message to the hang-state processing unit 110 and the hang-state processing unit 110 may detect or determine that the AP is in a hang state.

Although separate components are illustrated in FIG. 4, aspects of the invention are not limited thereto, such that two or more components may be integrated to operate as a single component.

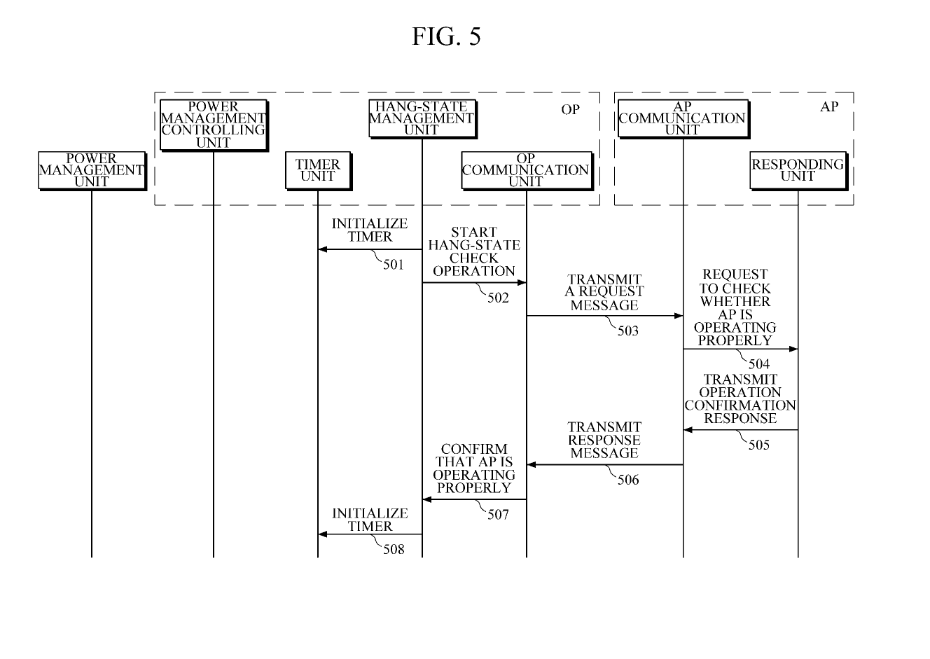

FIG. 5 is a flow chart illustrating a normal operation for managing a hang state according to an exemplary embodiment of the present invention.

Referring to FIG. 5, in the operation for managing a hang state, if an AP is operating properly, a hang-state management unit initializes a timer unit in operation 501. More specifically, the hang-state management unit may initialize the timer unit to execute a timing operation, in which the timing operation may run from a predetermined time period towards expiration or until a re-initialization signal is received. During the running of the predetermined time period set by the timer unit, the hang-state processing unit may transmit a signal to check whether the AP is operating properly and wait to receive a response about whether the AP is operating properly (e.g., operations 502-507). If the hang-state management unit fails to check whether the AP is operating properly at the expiration of the predetermined time period set by the timer unit, the hang-state processing unit may determines that the AP is in a hang state.

In operation 502, the hang-state management unit notifies an OP communication unit that a hang-state check operation has begun. Notifying the OP communication unit that the hang-state check operation has begun may include transmitting, to the OP communication unit, information to indicate that an operation to check whether the AP is in a hang state has begun. In response to notifying the OP communication unit that the hang-state check operation has begun, the hang-state management unit may wait to receive a response signal.

In operation 503, the OP communication unit transmits a request message to an AP communication unit. More specifically, in response to being notified by the hang-state management unit that the hang-state check operation has begun, the OP communication unit may generate a request message to check whether the AP is in a hang state. The request message may refer to a message requesting the responding unit of the AP to transmit a response message. The generated request message may be transmitted to the AP communication unit of the AP.

In operation 504, the AP communication unit requests that the responding unit check whether the AP is operating properly. More specifically, in response to receiving the request message from the OP communication unit, the AP communication unit may request that the responding unit check to determine whether the AP is operating properly.

In operation 505, the responding unit transmits a response that confirms that the AP is operating properly. More specifically, in response to being requested from the AP communication unit to check whether the AP is operating properly, the responding unit may transmit an operation confirmation response to the AP communication unit. If the AP is operating properly, the responding unit may be able to respond to the request message to check whether the AP is operating properly. However, if the AP is in a hang state and unable to operate properly, the responding unit of the AP may be unable to respond to the request message. Therefore, a determination of whether the AP is in a hang state may be made according to whether an operation confirmation response is received from the responding unit.

In operation 506, the AP communication unit transmits a response message to the OP communication unit. More specifically, in response to receiving the operation confirmation response from the responding unit, the AP communication unit may generate a response message and transmit the response message to the OP communication unit included in an OP.

In operation 507, in response to receiving the response message from the AP communication unit, the OP communication unit notifies the hang-state management unit of confirmation that the AP is operating properly. More specifically, according to a determination of whether the response message is received from the AP communication unit, the OP communication unit may confirm whether the AP is operating properly. In response to confirming that the AP is operating properly, the OP communication unit the hang-state management unit of confirmation that the AP is operating properly.

The hang-state management unit reinitializes the timer unit in operation 508. More specifically, if the OP communication unit confirms that the AP is operating properly, the hang-state management unit may reinitialize the timer unit to be executed. By doing the above-described process repeatedly, intermittently or on a regular basis, the OP may regularly check to determine whether the AP is in a hang state.

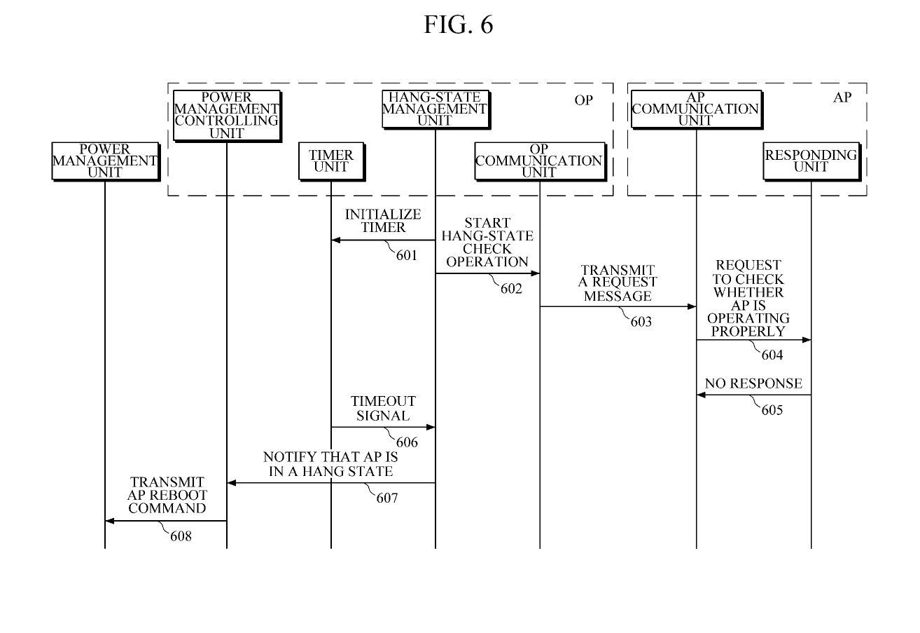

FIG. 6 is a flow chart illustrating a method for managing a hang state according to an exemplary embodiment of the present invention.

Referring to FIG. 6, a hang-state management unit initializes a timer unit when a hang state occurs in the AP in operation 601. More specifically, the hang-state management unit may initialize the timer unit to execute a timing operation, in which the timing operation may run from a predetermined time period towards expiration or until a re-initialization signal is received. During the running of the predetermined time period set by the timer unit, the hang-state management unit may transmit a signal to check whether the AP is operating properly and wait to receive a response about whether the AP is in a hang state (e.g., operations 602-606). If the hang-state management unit fails to receive a response signal to indicate that the AP is operating properly and not in a hang state by the expiration of the predetermined time period set the timer unit, the hang-state management unit may determine that the AP is in a hang state.

In operation 602, the hang-managing unit notifies an OP communication unit that the hang-state check operation has begun. More specifically, in order to check to determine whether the AP is in a hang state, the hang-managing unit may notify the OP communication unit that the hang-state checking operation has begun. Notifying the OP communication unit that the hang-state check operation has begun may include transmitting, to the OP communication unit, information that an operation to check whether the AP is in a hang state has begun. Further, the hang-state management unit may wait to receive a response signal.

The OP communication unit transmits a request message to an AP communication unit in operation 603. More specifically, in response to being notified that the hang-state check operation has begun, the OP communication unit may generate a request message to check whether the AP is in a hang state. The request message may refer to a message requesting a responding unit of the AP to transmit a response message. The generated request message may be transmitted to the AP communication unit of the AP.

The AP communication unit requests that the responding unit check whether the AP is in a hang state in operation 604. More specifically, in response to receiving the request message from the OP communication unit, the AP communication unit may request that the responding unit check to determine whether the AP is in a hang state.

If the AP is in a hang state and unable to operate properly, the responding unit of the AP may be unable to respond to the request to check whether the AP is operating properly in operation 605. More specifically, the AP communication unit may be unable to transmit a response message to the OP communication unit in response to the request message, such that the hang-state management unit may be unable to receive an operation confirmation signal. Although not illustrated, the AP communication unit may have a timer unit, which may run for a predetermined time period or until a response is received from the responding unit. If the AP communication unit fails to receive a response by the expiration of the predetermined time period, the AP communication unit may determine that the AP is not operating properly and transmit a signal to the OP communication unit. Further, the timer unit may be independent of the AP communication unit and may communicate with the AP communication unit to provide a timing operation.

The hang-state management unit receives a timeout signal from the timer unit in operation 606. More specifically, the hang-state management unit may wait to receive an operation confirmation signal from the OP communication unit. However, if the hang-state management unit does not receive the operation confirmation signal within a predetermined time period or prior to expiration of the predetermined time period set by the timer unit, the timer unit may notify the hang-state management unit of the expiration of the predetermined time period set by the timer unit. The predetermined time period set by the timer unit may refer to a wait time during which the hang-state management unit, which may have begun checking whether the AP is in a hang state, waits to receive a new signal. According to how long the predetermined time period is set to be, the hang-state management unit may wait for a long time period or for a short time period.

However, the operation confirmation signal may not be transmitted immediately due to a state of the AP. For example, the operation confirmation signal may not be transmitted if another operation having a higher priority is to be conducted first. Here, the operation confirmation signal may not be transmitted during the predetermined time set in the timer unit even though the AP may be operating properly. Thus, at or after expiration of the predetermined time period set by the timer unit, it may be possible to go back to operation 601 to recheck whether the AP is in a hang state. The recheck process may be performed one or more times according to purposes and settings.

In response to receiving the timeout signal, the hang-state management unit notifies a power management controlling unit that the AP is in a hang state in operation 607.

More specifically, in response to receiving the timeout signal received from the timer unit, the hang-state management unit may determine that the AP is in a hang state. In an attempt to resolve the hang state, the hang-state management unit may notify the power management controlling unit that the AP is in a hang state.

In response to being notified that the AP is in a hang state, the power management controlling unit transmits a reboot command to a power management unit in operation 608. More specifically, in response to being notified by the hang-state management unit that the AP is in a hang state, the power management controlling unit may transmits the reboot command to the power management unit in an attempt to reboot the AP. In response to receiving the reboot command, the power management unit may control power supply of the AP to resolve the hang state.

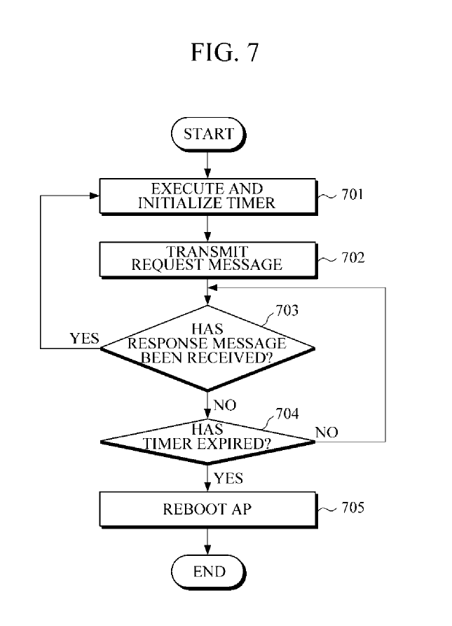

FIG. 7 is a flow chart illustrating a method for managing a hang state according to an exemplary embodiment of the present invention.

Referring to FIG. 7, in operation 701, a timer unit in one or more OPs, which may be disposed in an AP but operates independently of the AP, is executed and initialized. More specifically, the timer unit may be executed and initialized to initiate a determination of whether the AP is in a hang state. The predetermined period of time of the timer unit may refer to a wait time during which the hang-state management unit may wait to receive a response message in response to a request message transmitted to the AP.

In operation 702, one or more OPs, which may be operating independent of the AP, transmit a request message to a kernel layer of the AP. The request message may be a message for requesting the AP to transmit a response message that may be used to check whether the AP is in a hang state. More specifically, whether the AP is in a hang state may be determined according to whether the response message is received.

In operation 703, one or more OPs checks to determine whether the response message is received in response to the request message. More specifically, one or more OPs check to determine whether the response message is received from the AP in response to the request message. If the AP is operating properly, the AP may generate a response message in response to the request message and transmit the response message to the one or more OPs, which may be disposed in the AP but operates independent of the AP. If the response message is received by the one or more OPs, one or more OPs may determine that the AP is operating properly, reinitializes the timer unit to be run towards expiration from a predetermined period of time, which may be reset upon determination of the AP operating status, until a response signal is received. The above-described process for checking whether the AP is in a hang state may be performed repeatedly.

If the response message is not received, the one or more OPs checks to determine whether the timer unit has expired in operation 704. Further, in response to not receiving the response message from the AP by the expiration of the timer unit, one or more OPs disposed in the AP but operating independently of the AP may determine that the AP may not be operating properly. However, it may take long time or short time to receive the response message from the AP according to a state of the AP and a communication state. Thus, if the timer unit is checked and determined that the timer unit has yet to expire, the OP may proceed to wait to receive the response message until the predetermined period of time set by the timer unit expires. In other words, a predetermined time set by the timer unit may refer to a wait time before receiving the response message from the AP.

If the timer unit has expired, the AP is rebooted in operation 705. More specifically, if the response message is not received from the AP in response to the request message and the timer unit has expired, the one or more OPs may determine that the AP is in a hang state and may be unable to operate properly. Further, if the one or more OPs determine that the AP is in the hang state, a power controlling unit of a mobile terminal, such as a PMIC, may reboot the AP to resolve the hang state.

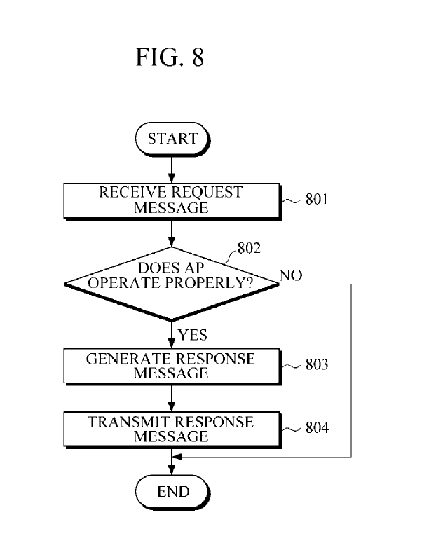

FIG. 8 is a flow chart illustrating a method for generating a response message according to an exemplary embodiment of the present invention.

Referring to FIG. 8, in operation 801, an AP receives a request message. In response to receiving the request message for checking whether AP is operating properly, a determination of whether the AP is operating properly is made in operation 802. If the AP is operating properly, a response message is generated in response to the request message in operation 803. In operation 804, the generated response message is transmitted to one or more processors, such as the OPs, which may be disposed in the AP but operate independent of the AP. In response to receiving the response message, a hang-state management unit may determine that the AP is operating properly. If the AP is not operating properly, the response message may not be generated in response to the request message and the hang-state management unit may not receive the response message. Accordingly, the hang-state management unit may determine that the AP is in a hang state.

Using the apparatus and method for managing a hang state of a mobile terminal, it may be able to detect the hang state occurring in the mobile terminal and reboot an AP to resolve the hang state. In addition, when the AP has a problem and thus cannot operate properly, a watch dog program in the related art may malfunction, but the apparatus to manage a hang state of a mobile terminal may be able to detect the hang state since the apparatus may operate in a processor independent of the AP of the mobile terminal.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for determining an operational status of a terminal, comprising:
transmitting, from a first processor to a second processor, a request message for determining a status of the second processor;
executing a timer operation for a time period;
determining that the second processor is in a hang state if a response message is not received from the second processor within the time period; and
transmitting, to a power management unit, a reboot command for rebooting the second processor if the second processor is determined to be in the hang state.

2. The method of claim 1, wherein the first processor reinitializes the timer operation if the response message is received from the second processor within the time period.

3. The method of claim 1, wherein the first processor comprises at least one of an operating processor, a baseband modem processor (BP), a communication processor (CP), and a digital signal processor (DSP).

4. The method of claim 1, wherein the second processor is an application processor (AP).

5. The method of claim 1, wherein the first processor and the second processor are physically connected to each other.

6. The method of claim 1, wherein the first processor operates independent of the second processor.

7. A terminal, comprising:
a first processor to transmit a status request message to a second processor, to initialize a timer to run until expiration of a time period, and to transmit a reboot command to a power management unit if the response message is not received within the time period; and
the second processor to determine its status and to transmit a response message prior to expiration of the time period if the second processor is operating normally.

8. The terminal of claim 7, wherein the power management unit reboots the second processor in response to the reboot command.

9. The terminal of claim 7, wherein the first processor comprises at least one of an operating processor, a baseband modem processor (BP), a communication processor (CP), and a digital signal processor (DSP).

10. The terminal of claim 7, wherein the second processor is an application processor (AP).

11. The terminal of claim 7, wherein the first processor reinitializes the timer if the status response message is received from the second processor.

12. The terminal of claim 7, wherein the first processor and the second processor are physically connected to each other.

13. The terminal of claim 7, wherein the first processor operates independent of the second processor.

14. The terminal of claim 7, wherein the power management unit includes a Power Management Integrated Circuit (PMIC).

15. The terminal of claim 7, wherein the first processor communicates with the second processor using Inter-processor communication (IPC).

16. A method for determining an operational status of a terminal, comprising:
transmitting, from a first processor to a second processor, a first request message for determining a status of the second processor;
executing a timer operation for a time period; and
determining that the second processor is in a hang state if a response message is not received from the second processor within the time period.

17. The method of claim 16, wherein the first processor and the second processor are physically connected to each other.

18. The method of claim 16, wherein the first processor operates independent of the second processor.

19. The method of claim 16, wherein a second request message to a second processor for confirming a status of the second processor in response to a determination that the second processor is in a hang state.

20. The method of claim 17, wherein the first processor transmits the second request message at a predetermined time.
